(19) United States
(12) Patent Application Publication
(10) Pub. No.: US 2019/0100872 A1
(43) Pub. Date: Apr. 4, 2019

(54) Systems, Methods, And Article For Preserving A Look Of A Garment

(71) Applicant: VF Jeanswear LP, Greensboro, NC (US)

(72) Inventors: Sudhakar PUVVADA, Cary, NC (US); Dennis SCHEER, Greensboro, NC (US); Paul G. HOERTZ, Hillsborough, NC (US); Rajeev RAJBHANDARI, Bogart, GA (US); Akash PARDESHI, Greensboro, NC (US)

(21) Appl. No.: 16/150,077

(22) Filed: Oct. 2, 2018

Related U.S. Application Data
(60) Provisional application No. 62/566,795, filed on Oct. 2, 2017.

(51) Int. Cl. D06P 3/60; D06P 5/08; C11D 3/40; C11D 11/00

(52) U.S. Cl. CPC D06P 3/6025; C11D 11/0017; C11D 3/40; D06P 5/08

(57) ABSTRACT

Provided are methods for treating garments so as to improve color contrast, darkness, or both. Also provided are systems for treating garments as well as garments made according to the disclosed methods.

### RELATED APPLICATION

The present application claims priority to and the benefit of U.S. patent application No. 62/566,795, “Systems, Methods, and Article for Preserving a Look of a Garment” (filed Oct. 2, 2017), the entirety of which application is incorporated herein by reference for any and all purposes.

### TECHNICAL FIELD

The present disclosure relates to the field of shade maintaining treatments for garments.

### BACKGROUND

In the garment field, there is a long-felt—and increasing—need for garments that are capable of retaining their look for longer periods of time. Garments can have a range of colors and can also include tinting, but garment appearance fades over time, and in some cases, appearance can fade relatively quickly with washing. In addition to losing their appearance relatively quickly, certain shaded garments can also exhibit unfavorable feel characteristics.

Accordingly, there is a need in the art for methods (and related systems) for producing garments—in particular darkly-colored garments, but also medium- and light-colored garments as well as tinted garments—that exhibit favorable shade and/or contrast and that maintain that favorable shade and/or contrast over periods of wear and washing. Meeting this need will increase the length of time that consumers use their clothing and as a result will reduce the amount of garments that are discarded.

### SUMMARY

In meeting the long-felt needs described above, the present disclosure first provides methods for treating a garment, comprising (a) fabricating a garment; (b) optionally performing a dry finishing on the garment; (c) optionally performing a wet finishing on the garment; (d) optionally tinting the garment (e) washing the garment with an amount of a contrast material that that comprises perpendicular light-polarizing axes, the washing giving rise to a treated garment; (f) optionally treating the garment with resin and/or a functional finish; (g) drying the garment; and (h) optionally curing the garment.

Also provided are garments made according to the methods disclosed herein.

Further provided are garment manufacturing systems, comprising: a pre-treatment garment fabrication stage; and a garment stage, comprising (a) a receiving vessel for pre-treatment garments, (b) a dispenser configured to dispense a treatment into the receiving vessel so as to effect application of the treatment to pre-treatment garments disposed within the vessel so as to give rise to treated garments, and (c) a supply of a contrast material that comprises perpendicular light-polarizing axes, the supply of contrast material being in fluid communication with the dispenser.

### BRIEF DESCRIPTION OF THE DRAWINGS

The patent or application file contains at least one drawing executed in color. Copies of this patent or patent application publication with color drawing(s) will be provided by the office upon request and payment of the necessary fee.

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawing:

FIG. 1 provides a flowchart of an exemplary process according to the present disclosure;

FIG. 2A and FIG. 2B provide photos of exemplary fabric panels treated according to the present disclosure (associated with Example 10); and

FIG. 3A and FIG. 3B provide photos of exemplary fabric panels treated according to the present disclosure (associated with Example 11).

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Numerical values in the specification and claims of this application, particularly as they relate to polymers or polymer compositions, oligomers or oligomer compositions, reflect average values for a composition that can contain individual polymers or oligomers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

### Definitions

As used herein, “garment” means an item of clothing wherein the fabric that makes up the garment has been assembled into the garment, e.g., a pair of pants or a jacket, such that the garment is ready to wear. It should be understood that a “garment” for purposes of the present disclosure need not be fully complete and can be missing one or more ornamental features (e.g., rhinestones), closures (e.g., buttons), or other features that can be comprising on or in the garment when the garment is offered for sale to consumers. A pre-treatment garment can be a garment, as previously defined, that has yet to undergo a certain treatment, e.g., a spraying or dipping application. The term “pre-treatment garment” can refer to a garment that has not yet been contacted with a contrast material, as described herein. It should be understood that the term “garment” is not limited to any particular type of clothing article and can include, e.g., pants, shirts, jackets, robes, dresses, formal wear, business wear, athletic apparel, leisure wear, footwear, outerwear, intimates, and the like.

As used herein, a “contrast material” means a treatment (e.g., a polymeric treatment) that is effective in maintaining a level of shade in a given garment. In some cases, a “contrast material” can itself impart a degree of shade to a given garment, though this is not a requirement. A contrast material can effect light scattering and/or light polarization.

As one non-limiting example, Dicrylan SD™ is considered a suitable contrast material; suitable contrast materials include polymers that comprise perpendicular light-polarizing axes. Other suitable contrast materials include, e.g., Sarex™ (color blooming agent specially developed for enhancing shade in cotton, wool, polyester and their blends; the agent is considered particularly suitable for black and navy blue dyed fabrics); Garmon™ (polymer mixture for indigo and sulfur dye fixation); and Nearchemica™ (self-cross linking poly-functional elastomeric silicone, used to obtain special finishing effects on cotton, silk, wool, synthetic fibers, viscose and their blends).

### Exemplary Embodiments

The following Embodiments are exemplary only and do not serve to limit the scope of this disclosure, including the attached claims.

### Embodiment 1

A method for treating a garment, comprising the following steps: (a) fabricating a garment; (b) optionally performing a dry finishing on the garment; (c) optionally performing a wet finishing on the garment; (d) optionally tinting the garment (e) washing the garment with an amount of a contrast material (e.g., a known or estimated amount) that that comprises perpendicular light-polarizing axes, the washing giving rise to a treated garment; (f) optionally treating the garment with resin and/or a functional finish; (g) drying the garment; and (h) optionally curing the garment.

The application of the contrast material can be effected at any stage following garment fabrication. For example, contrast material can be applied before any performance of wet or dry finishing on the garment.

Without being bound to any particular theory, the foregoing approach is contrary to the conventional wisdom of applying a contrast material at a relatively early process stage (e.g., applying the material to yarn or to fabric that has not been fabricated into a garment) on the ground that it is more cost-efficient to apply the contrast material at the earlier stage of the process. In addition, the conventional wisdom also holds that one can achieve greater uniformity of application if the contrast material is applied at an earlier stage of the process to a relatively uniform substrate (e.g., yarn) instead of to a garment-stage article that can present an effectively non-uniform substrate to the contrast material.

Fabricating a garment can include, e.g., cutting fabric, sewing fabric, inserting grommets, snaps, zippers, or other closures, and the like. Fabricating a garment can include attaching trim materials or even attaching other components (e.g., ribbed cuffs) to the garment. Fabricating can also include dyeing, tinting, or otherwise coloring a garment or part of the garment.

A user can perform one or more dry finishing steps on a garment, in some embodiments of the disclosed technology. Exemplary such steps include, e.g., sanding, laser treatment, brushing, whiskering, raising, shearing, fulling, compacting, embossing, napping, calendaring, or other dry finishing treatments known to those of ordinary skill in the art.

A user can also perform one or more wet finishes on a garment. Exemplary wet finishes include, e.g., softening, application of an elastomeric finish, application of a bleach, application of a crease-resistant or crease-proof treatment, application of a soil release treatment, application of a flame retardant treatment, application of an anti-pilling finish, application of a non-slip finish, application of a stain/soil resistant finish, application of an oil-proof and/or waterproof finish, application of an absorbent finish, application of an anti-static finish, application of an anti-mildew finish, application of a mothproofing finish, application of an antibacterial finish, application of an ultraviolet-resistant finish, application of a colorfast finish, or even application of a plasma finish. Other suitable finishes include stonewashing and enzyme washing. It should be understood that any of the foregoing steps can be combined and performed simultaneously or performed in sequence.

The washing (e.g., with the contrast material) can be performed by, e.g., spraying, dipping, immersing, agitating, or any combination thereof. Suitable washing methods will be known to those in the art. As one non-limiting example, washing conditions can be washing for 1-30 minutes at a temperature of from about 25 to about 50 deg. C., at a pH of from about 4 to about 8, and at a loading level of about 5:1.

The garment being washed is suitably free of sizing materials. A garment being washed can optionally have a cure or functional finish, but this is not a requirement, as a garment can also be free of a cure or functional finish.

The level of contrast material loading (i.e., concentration) can depend on the needs of the user. Surprisingly, it has been found that the effectiveness of a contrast material can increase—in some instances, dramatically—with increasing contrast material loading level, which is contrary to the accepted wisdom that the effectiveness of a fabric treatment can increase, if at all, only gradually or in a linear manner with increasing exposure to a treatment of interest. One would typically expect that as one treats the full surface of the garment, after one arrives at full treatment coverage, one would expect performance to plateau or even to drop, not to increase.

As explained, the claimed methods can also include optionally treating the garment with resin, tinting the garment, curing the garment, fixing the garment, or any combination of the foregoing. Suitable resins and tints will be known to those of ordinary skill in the art. Suitable curing processes include, e.g., a process of 1-30 minutes at 150 deg. C. (+/−) 25 deg. C., which can be performed as tunnel curing, or as a batch, continuous, discontinuous, or tumble curing process. The disclosed methods can also include drying the garment. Drying can be effected by, e.g., ambient air, forced air, heated air, reduced pressure, a dehumidification process, and the like.

A garment made according to the disclosed methods can exhibit a change in L value that is less than about 10%, less than about 5%, less than about 3%, less than about 2%, or even less than about 1% following 3 washes.

A garment made according to the disclosed methods can exhibit a change in L value that is less than about 25%, less than about 22.5%, less than about 20%, less than about 17%, or even less than about 15% following 15 washes. A garment made according to the disclosed methods can exhibit a change in L value, following 15 washes, that is in the range of from about 20% to about 5%, from about 17% to about 8%, from about 15% to about 10%, or even from about 14% to about 11%. (The foregoing can be measured relative to 0 washes.)

A garment made according to the disclosed methods can have an L value at 0 washes of from −1 to about 1. Following 10 washes, such a garment can have an L value that is greater than the L value at 0 washes, with the post-10-wash L value being less than about 2 (e.g., from about 0 to less than 2, or from about 0.5 to about 1.5), or even less than about 1. Following 15 washes, such a garment can have an L value that is greater than the L value at 10 washes, with the post-15-wash L value being less than about 5 (e.g., from about 2 to about 4), or even less than about 3.

A garment made according to the disclosed methods can exhibit a change in L value that is less than 2, less than 1.7, or even less than 1.5 in going from 5 washes to 10 washes.

A garment made according to the disclosed methods can exhibit a change in b value that, following 5 washes, is less than about 3, less than about 2.5, or even less than about 2. The change in b value following 5 washes can be from about 1 to about 3. A garment made according to the disclosed methods can exhibit a change in b value that, following 10 washes, is less than about 5, less than about 3.5, or even less than about 3. The change in b value following 10 washes can be from about 4.5 to about 3. (The foregoing can be measured relative to 0 washes.)

A garment made according to the disclosed methods can exhibit a Delta E (CMC) value that, following 5 standard washes, is less than about 5, less than about 4, less than about 2.5, or even less than about 2. The Delta E value following 5 washes can be from about 1 to about 3. A garment made according to the disclosed methods can exhibit a Delta E that, following 10 washes, is less than about 6, less than about 5.5, or even less than about 5. The Delta E value following 10 washes can be from about 2 to about 4. (The foregoing can be measured relative to 0 washes.)

### Embodiment 2

The method of Embodiment 1, wherein the contrast material is present during the washing at from about 1 to about 50 wt % of the garment weight. As one example, a garment load of 50 pounds might be contacted with 20 pounds of contrast material. The concentration of the contrast material can be varied according to the needs of the user.

### Embodiment 3

The method of any of Embodiments 1-2, wherein the treated garment has a drape coefficient of from about 1 to about 100%. A treated garment can have a drape coefficient of from about 1 to about 100%, or from about 5 to about 95%, or from about 10 to about 90%, or from about 15 to about 85%, or from about 20 to about 80%, or from about 25 to about 75%, or from about 30 to about 65%, or from about 35 to about 60%, or from about 40 to about 55% or even from about 45 to about 55%. The drape coefficient can be modulated by, e.g., the choice of fabric for the garment, as well as the choice of other treatments (e.g., the selection of a particular dry finish).

Drape can be evaluated by, e.g., the Kawabata Evaluation System (KES) known to those of skill in the art, which system is used to determine the tactile qualities through objective measurement of the mechanical properties related to fabric hand. With low forces applied, as in manipulating/touching fabrics, this series of instruments includes determinations for tensile properties (stretch), shear stiffness (drape), bending rigidity (flexing), compression (thickness, softness), and surface friction and roughness Drape can also be assessed using the Collier test approach, also known to those of skill in the art.

### Embodiment 4

The method of any of Embodiments 1-3, wherein the treated garment has a drape coefficient that differs from the drape coefficient of the garment before washing by at least about 2%. As some examples, the treated garment can have a drape coefficient that differs from the drape coefficient of the garment before washing by at least about 2%, at least about 10 g %, at least about 15%, at least about 20%, at least about 25%, at least about 30%, at least about 35%, at least about 40%, at least about 50%, at least about 55%, at least about 55%, or even by at least about 60%. The treated garment can have a drape coefficient that differs from the drape coefficient of the garment before washing by from about 2% to about 50%, by from about 5% to about 45%, by from 10% to about 40%, by from 15% to about 35%, or even by from 20% to about 25%. In some embodiments, (a) the treated garment has a drape coefficient of from about 1 to about 100%, (b) the treated garment has a drape coefficient that differs from the drape coefficient of the garment before washing by at least about 2%, or both (a) and (b).

### Embodiment 5

The method of any of Embodiments 1-4, wherein the treated garment has a Delta E CMC (which can also be termed DECMC or dECMC) of less than about 5 following 5 washes under standard conditions.

### Embodiment 6

The method of Embodiment 5, wherein the treated garment has a Delta E CMC (which can also be termed DECMC or dECMC) of less than about 4 following 5 washes under standard conditions.

Exemplary standard conditions can be home washing. Exemplary conditions can also be found in AATCC Monograph M6-2016, “Standardization of Home Laundry Test Conditions,” using AATCC Standard Reference High Efficiency Detergent (without brightener), per Table III (temperature: cold) and per Table V (sample conditions) in the foregoing monograph. Other exemplary standard washing (and drying) conditions are found in the attached examples.

### Embodiment 7

The method of any of Embodiments 1-6, wherein the pre-treatment garment is substantially free of the contrast material. Thus, in some embodiments, little to no contrast material is present on a garment until the garment has been fabricated, i.e., no contrast material is present on the garment until after the garment is constructed. Without being bound to any particular theory, this approach represents a departure from existing approaches that comprise applying a contrast material to constituents (e.g., yarn, fabric) of a garment before those components are assembled to form the ultimate garment.

### Embodiment 8

The method of any of Embodiments 1-7, wherein the treated garment is characterized as having an inner surface and an outer surface, and wherein a concentration of the contrast material has maxima at the inner surface and outer surface of the garment. It should be understood that this is exemplary only, as some garments can have an essentially uniform concentration of the contrast material through the thickness of the garment. It should be understood that in some embodiments, thread comprised within a garment (e.g., sewing thread used to sew the garment) comprises at least some of the contrast material. Pockets, collars, cuffs, and the like can also comprise some amount of the contrast material.

### Embodiment 9

A treated garment made according to any of Embodiments 1-8. Without being bound to any particular theory, denim fabrics are considered particularly suitable for the disclosed technology, although other fabric types can of course be used.

### Embodiment 10

The treated garment of Embodiment 9, wherein (a) the garment exhibits a stretch recovery of from about 85 to about 100% and/or of at least about 1% (per ASTM D3701, as of Sep. 29, 2016), wherein (b) the garment comprises pervious materials and all pervious materials of the garment compriseg at least some amount of the contrast material, or both (a) and (b).

Without being bound to any particular theory, use of the contrast material can reduce thread-thread friction, thus resulting in an increased stretch recovery. Stretch recovery can be enhanced by about, e.g., 1, 2, 3, 4, 5, 6, 7, 8, 9, or even 10% as compared to a comparable garment that has not been treated with the contrast material.

### Embodiment 11

The treated garment of any of Embodiments 9-10, wherein the treated garment comprises denim, an indigo-dyed fabric, or both.

### Embodiment 12

A garment manufacturing system, comprising: a pre-treatment garment fabrication stage; and a garment stage, comprising (a) a receiving vessel for pre-treatment garments, (b) a dispenser configured to dispense a treatment into the receiving vessel so as to effect application of the treatment to pre-treatment garments disposed within the vessel so as to give rise to treated garments, and (c) a supply of a contrast material that comprises perpendicular light-polarizing axes, the supply of contrast material optionally being in fluid communication with the dispenser.

As described elsewhere herein, a pre-treatment garment fabrication stage can comprise fabric cutting, fabric sewing, affixation of trim, and the like. A dispenser according to the present disclosure can comprise, e.g., a sprayer, a tank in connection with the receiving vessel (the tank can dispense its contents into the vessel via gravity and/or via mechanically-assisted methods). The vessel can be a stirred tank, a rotating vessel (e.g., a drum), a tank into which garments are immersed (e.g., on a clothing rack), or other vessels known to those of ordinary skill in the art. The supply of contrast material can be in a tank or other vessel; the contrast material can be blended with one or more additional components (e.g., water, hydrocarbon, acetone, alcohol, or other carrier/solvent) before, during, or following introduction to the receiving vessel. A receiving vessel can be, e.g., 5 gallons, 10 gallons, 50 gallons, and larger, depending on the needs of the user.

### Embodiment 13

The garment manufacturing system of Embodiment 12, wherein the system is configured to effect application of the treatment at from about 0.1 to about 50 wt % of pre-treatment garments present in the receiving vessel, e.g., from about 1 to about 50 wt %, from about 5 to about 45 wt %, from about 10 to about 40 wt %, from about 15 to about 35 wt %, from about 20 to about 30 wt %, or even about 25 wt %. As one example, 100 kg of pre-treatment garments might be treated with 25 kg of contrast material.

### Embodiment 14

The garment manufacturing system of any of Embodiments 12-13, wherein the system is configured to give rise to treated garments having a drape coefficient of from about 1 to about 100%. A treated garment can have a drape coefficient of from about 1 to about 100%, or from about 5 to about 95%, or from about 10 to about 90%, or from about 15 to about 85%, or from about 20 to about 80%, or from about 25 to about 75%, or from about 30 to about 65%, or from about 35 to about 60%, or from about 40 to about 55% or even from about 45 to about 55%. The drape coefficient can be modulated by, e.g., the choice of fabric for the garment, as well as the choice of other treatments (e.g., the selection of a particular dry finish).

### Embodiment 15

The garment manufacturing system of any of Embodiments 12-14, wherein the system is configured to give rise to treated garments having a Delta E CMC (which can also be termed DECMC or dECMC) of less than about 5 following 5 washes under standard conditions.

### Embodiment 16

The garment manufacturing system of any of Embodiments 12-15, wherein the pre-treatment garments are substantially free of the contrast material. Again without being bound to any particular theory, this approach represents a departure from existing approaches that comprise applying a contrast material to components (e.g., sleeves, cuffs) of a garment before those components are assembled to form the ultimate garment product.

### Embodiment 17

The garment manufacturing system of any of Embodiments 12-16, wherein the system is configured such that application of the contrast material effects a Delta E CMC in the pre-treatment garments of less than about 10%, e.g., 9, 8, 7, 6, 5, 4, 3, 2, or even 1%. Put another way, in some embodiments, the application of the contrast material can effect a surprisingly small change on the initial color levels of the garment.

### Embodiment 18

The garment manufacturing system of any of Embodiments 12-17, wherein the system is configured to give rise to a non-uniform concentration of the contrast material as a function of depth through a thickness of a treated garment. For example, the concentration of the contrast material can be at a maximum on the interior surface of the garment or even at a maximum on the outer surface of the garment.

### Embodiment 19

The garment manufacturing system of any of Embodiments 12-18, further comprising one or more garments disposed within the receiving vessel. The garments can be of the same or different type, e.g., only pants, or both pants and jackets.

### Embodiment 20

The garment manufacturing system of any of Embodiments 12-19, further comprising a dry finishing stage configured to effect a dry finishing on a garment or pre-treatment garment. Suitable dry finishes are described elsewhere herein and include, e.g., sanding, laser treatment, brushing, whiskering, raising, shearing, fulling, compacting, embossing, napping, calendaring, or other dry finishing treatments known to those of ordinary skill in the art. Dry finishing can be effected at a stage before or after application of the contrast material to the pre-treatment garment.

### Embodiment 21

The garment manufacturing system of any of Embodiments 12-20, further comprising a wet finishing stage configured to effect a wet finishing on a garment or pre-treatment garment. The disclosed systems can comprise at least one of (a) a dry finishing stage configured to effect a dry finishing on a garment or pre-treatment garment and (b) a wet finishing stage configured to effect a wet finishing on a garment or pre-treatment garment.

A user can also perform one or more wet finishes on a garment. Exemplary wet finishes include, e.g., softening, application of an elastomeric finish, application of a bleach, application of a crease-resistant or crease-proof treatment, application of a soil release treatment, application of a flame retardant treatment, application of an anti-pilling finish, application of a non-slip finish, application of a stain/soil resistant finish, application of an oil-proof and/or waterproof finish, application of an absorbent finish, application of an anti-static finish, application of an anti-mildew finish, application of a mothproofing finish, application of an antibacterial finish, application of an ultraviolet-resistant finish, application of a colorfast finish, or even application of a plasma finish. The wet finishing stage can be effected at a stage before or after application of the contrast material to the pre-treatment garment.

### Embodiment 22

A method for preserving one or more aesthetics of a garment, comprising: treating a garment with a contrast material; and optionally performing one or more of a wet finishing on the garment, a dry finishing on the garment, treating the garment with resin, tinting the garment, curing the garment, or fixing the garment.

### Embodiment 23

The method of Embodiment 22, wherein an aesthetic comprises a color depth, a contrast, a drape, a softness, a color fastness to washing, or a color fastness to rubbing.

### Embodiment 24

The method of any of Embodiments 22-23, wherein the treating effects an increase in a color depth of up to about 20%, 30%, 40%, 50%, 60%, 70%, 80%, 90%, or even 100%. In some embodiments, the increase in color depth is from about 20% to about 100%.

### Embodiment 25

The method of any of Embodiments 22-24, wherein the treating gives rise to a treated garment having a Delta E CMC of less than about 5 following 5 washes under standard conditions.

### Embodiment 26

The method of any of Embodiments 22-25, wherein the garment comprises denim, an indigo-dyed fabric, or both.

### Exemplary Illustration

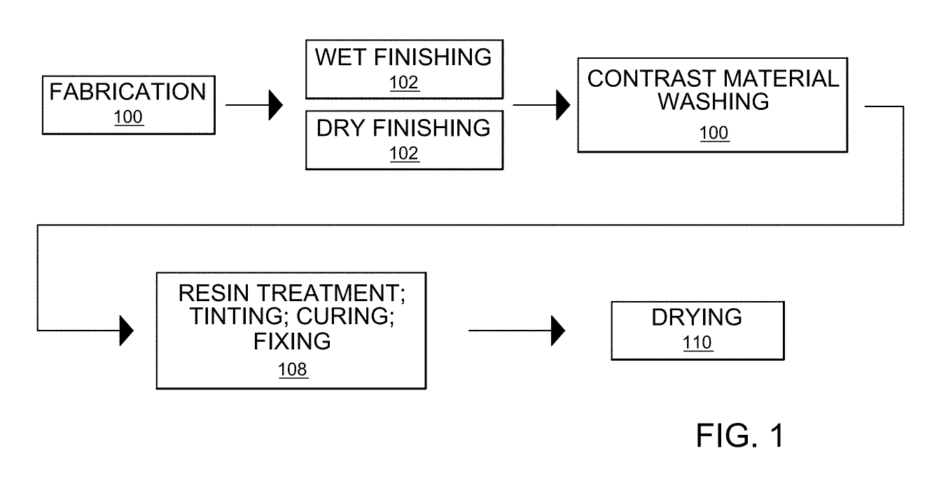

An exemplary method according to the present disclosure is provided in FIG. 1 attached hereto. As shown in FIG. 1, an exemplary process can begin with a fabrication stage 100. The fabrication stage can include—as described elsewhere herein—steps of cutting, sewing, and otherwise assembling an article of clothing. Following fabrication, the article of clothing can optionally be subjected to one or both of a wet finishing stage 102 and/or a dry finishing stage 104. Suitable wet finishing and dry finishing processes are described elsewhere herein. The article of clothing can then be washed with a contrast material at stage 106. As described elsewhere herein, the washing stage 106 can include dipping, spraying, agitating, or other application techniques known to those of skill in the art. An article can also be subjected to one or more of resin treatment, tinting, curing, and/or fixing at stage 108. The foregoing can be carried out in a single process or in multiple steps. A garment, treated with contrast material, can then be dried at drying stage 110.

It should be understood that a garment can be wet-finished, dry-finished, or both before the garment is washed with contrast material. Similarly, a garment can be subjected to one or more of resin treatment, tinting, curing, or fixing before the garment is washed with contrast material. It should further be understood, as described above, that any of steps 102, 104, and 108 shown in FIG. 1 are optional and are not required. It should be further understood that the application (106) of the contrast material can be performed at any time after fabrication step 100, e.g., after step 108. Put another way, the contrast material can be added at any time during the wash process of the garment, following the garment's fabrication.

### Illustrative Examples

A number of examples are provided below, showing exemplary results from subjecting a variety of garments to the disclosed methods, with the garments (slacks, shirts, wovens, and knits) including, e.g., indigo, indigo sulfur, black sulfur, and black over black sulfur treatment. The input of the contrast material, based on the weight of the garments, was from about 0.6 to about 30 wt %.

As shown below, treated garments were observed to exhibit improved retention of color and/or contrast with subsequent washings, as well as enhanced drape characteristics.

Examples 1-4 represent non-denim fabrics with a range of colors and fabric constructions. Examples 5-11 represent denim including tints. In Examples 5-11, significant improvement across various measures (less change over multiple washes) was seen, with improvement getting enhanced with dosage.

Brightness is represented by L values, with a change in b value (yellow-blue) representing mostly tints. For non-denim samples and 98BTTDY denim styles, the Color Muse™ system was used for color measurements. For 97FXWXD, 96501MR, 99RHWIH, RA3713-57, and RA3642A11 samples, a HunterLab™ spectrophotometer was used for color measurements.

### Material Application

An exemplary contrast material (Dicrylan SD™) was applied to finished garments in a washer. The washer was run for 10 minutes with a load ratio of 1:6, pH 4-5, extracted and dried at mid temp 60 deg. C.

### Laundry Conditions

Home laundry (also termed “HL”) testing on garments was simulated using a modified AATCC TM 135 wash method with Tide™ Free and Gentle detergent.

Washing conditions were as follows: Load weight: 1.81 kg (with ballast); Water temp: cool (˜room temperature); Settings/keys: Medium; Time: ˜45 for full cycle; Model: Amana™ (high efficiency); Detergent: Tide™ Free and Gentle.

Drying conditions were as follows:

Dry: High Cotton; Settings/keys in washer: High cotton; Time: 35-45 minutes; Temp ˜60-70 deg. C.; Model: Kenmore™.

### Example 1

Red Polo Shirt (Red polo shirt—mesh shirt, 26 singles, 100% cotton, single knit mesh-swiss pique). L values were measured as a function of the number of washes.

TABLE 1
Results from the material of Example 1.

| Home Laundries | Untreated | Treated |
|---|---|---|
| 0 | 42.1 | 42.0 |
| 3 | | 41.0 |

### Example 2

Purple Jersey (interlock jersey 100% poly, 30 to 40 singles). L values were measured as a function of washes.

TABLE 2
Results from the material of Example 2.

| Home Laundries | Untreated | Treated |
|---|---|---|
| 0 | 27.6 | 26.1 |
| 3 | | 26.4 |

### Example 3

Burgundy Jersey (single knit jersey 20-40 singles, 100% cotton). L values were measured as a function of washes.

TABLE 3
Results from the material of Example 3.

| Home Laundries | Untreated | Treated |
|---|---|---|
| 0 | 29.7 | 28.6 |
| 3 | | 29.0 |

### Example 4

Khaki Twill (15 single 2/1 100% cotton). L values were measured as a function of washes.

TABLE 4
Results from the material of Example 4.

| Home Laundries | Untreated | Treated |
|---|---|---|
| 0 | 56.2 | 54.6 |
| 3 | | 53.8 |

As shown above in examples 1-4, the brightness did not change significantly with treatment application.

### Example 5

Tinted denim using 97FXWXD material (tinted garment, 99% cotton, 1% spandex, 12 oz. Indigo with sulfur top) was tested. Provided below are the changes in b values from the inside of the denim garment as a function of washes.

TABLE 5
Results from the material of Example 5.

| | | Treated at | Treated at 18% |
|---|---|---|---|
| Home Laundries | Untreated | 6% loading | loading |
| 0 | 0 | 0 | 0 |
| 5 | −4.1 | −1.9 | −1.6 |
| 10 | −5.6 | −3.1 | −4.1 |
| 15 | −6.6 | −5.3 | −4.5 |

As shown, in the exemplary data above, there was a decrease in delta b value with treatment. The drop increased with increased dosing and the drop persisted over multiple washes. Without being bound to any particular theory, this indicates that with contrast material treatment, the tint of the garment was retained for longer periods of time.

### Example 6

Tinted Denim using 97FXWXD material (tinted garment, 99% cotton, 1% spandex, 12 oz., Indigo with sulfur top) was tested. Provided below is the Delta E value from the inside of the denim garment, as a function of washes.

TABLE 6
Results from the material of Example 6.

| | | TREATED | TREATED |
|---|---|---|---|
| Home Laundries | UNTREATED | 6% | 18% |
| 0 | 0 | 0 | 0 |
| 5 | 5.4 | 2.5 | 2.3 |
| 10 | 7.4 | 4.3 | 5.5 |
| 15 | 8.8 | 7.0 | 6.1 |

The data above show a significant drop in delta E value with treatment. The drop increases with increased dosing and the delta E drop persists over multiple washes, indicating that color was retained for longer than without treatment.

### Example 7

Tinted Denim using 98BTTDY material (tinted garment, 87% cotton, 12% poly, 1% spandex, 11.6 oz., pure indigo). L values were measured on the front of the garment.

TABLE 7
Results from the material of Example 7.

| | | TREATED | TREATED |
|---|---|---|---|
| Home Laundries | UNTREATED | 6% | 18% |
| 0 | 27.0 | 26.7 | 27.2 |
| 15 | 33.3 | 31.5 | 29 |
| Change | 6.3 | 4.8 | 1.8 |

The change even after 15 washes decreases with treatment and with increased dosage, showing the color/look is retained for longer than without treatment.

### Example 8

Tinted Denim, using 99RHWIH material (non-tinted garment, 100% cotton, 11 oz., pure indigo) was tested. Change in L value (from 0 HL washes) was measured using the outside of the garment.

TABLE 8
Results from the material of Example 8.

| Home | UN- | TREATED | TREATED | | |
|---|---|---|---|---|---|
| Laundries | TREATED | 6% | 18% | TREATED | TREATED |
| 0 | | | | | |
| 5 | 1.5 | 1.1 | −0.3 | −0.2 | −2.6 |
| 10 | 3.5 | 1.6 | 2.3 | 0 | .9 |
| 15 | 3.5 | 3.0 | 3.3 | 2.3 | .9 |
| 20 | 4.3 | 5.9 | 2.9 | 1.9 | 2.7 |

The change in brightness was reduced over multiple washes, and the benefit was enhanced as a function of dosage.

### Example 9

Tinted Denim, using 96501MR fabric (non-tinted mass garment, 100% cotton, 14.75 oz., pure indigo) was tested. Change in L value measured as a function of washes on the outside of the garment.

TABLE 9
Results from the material of Example 9.

| | | TREATED |
|---|---|---|
| Home Laundries | UNTREATED | 6% |
| 0 | | |
| 5 | 0.4 | .8 |
| 10 | 2.0 | 1.3 |

### Example 10

Fabric Details (RA3713-57): Pure Indigo; 74% cotton, 12% poly, 12% poly (sultan), 2% PU (spandex). Quantitative spectrophotometry (using a Hunter spectrophotometer)—indicates that treated garments retained more color than untreated garments over home laundry.

TABLE 10
Results (L-values) from the material of Example 10.

| Home Laundries | Untreated | Treated/6% | Treated/18% |
|---|---|---|---|
| 5 | 1.18 | 0.17 | −0.40 |
| 10 | 3.66 | 1.49 | 0.92 |
| 15 | 5.12 | 2.74 | 1.47 |
| 20 | 7.36 | 3.37 | 3.81 |

TABLE 11
Results (B-values) from the material of Example 10.

| Home Laundries | Untreated | Treated/6% | Treated/18% |
|---|---|---|---|
| 5 | −3.52 | −1.09 | −1.63 |
| 10 | −4.27 | −1.64 | −2.20 |
| 15 | −5.14 | −2.83 | −2.70 |
| 20 | −5.80 | −2.71 | −3.25 |

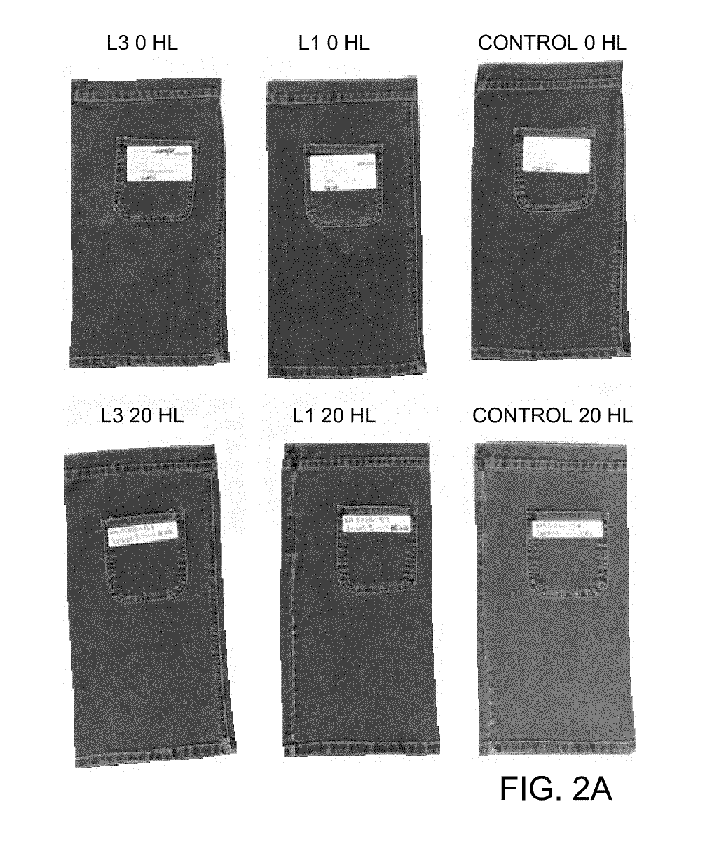

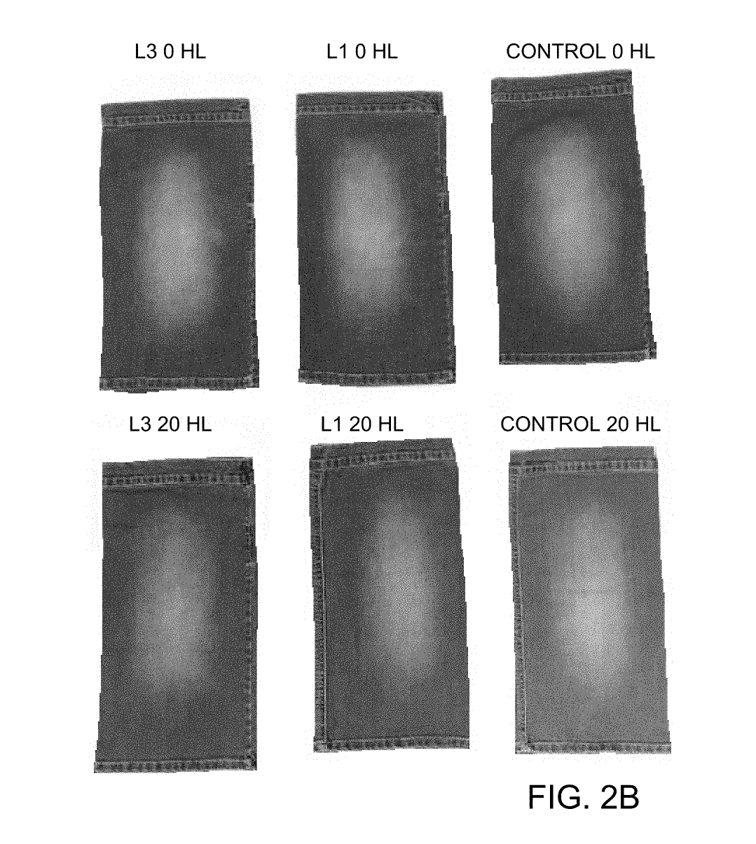

The qualitative visual information provided in FIGS. 2A and 2B shows that treated panels better retained color than untreated panels, as there were smaller changes with HL cycles in the L- and B-values of the treated panels.

### Example 11

Fabric Details (RA3642A11): Indigo bottom, sulfur top; 80% cotton, 9% poly, 9% poly (sultan), 2% PU (spandex). Quantitative spectrophotometry (using a Hunter spectrophotometer) indicates that treated garments retained more color than untreated garments over home laundry.

TABLE 12
Results (L-values) from the material of Example 11.

| Home Laundries | Untreated | Treated 6% | Treated 18% |
|---|---|---|---|
| 5 | 1.22 | −0.30 | 0.70 |
| 10 | 4.43 | 0.38 | 1.26 |
| 15 | 5.22 | 0.70 | 2.30 |
| 20 | 8.31 | 2.32 | 3.18 |

TABLE 13
Results (B-values) from the material of Example 11.

| Home Laundries | Untreated | Treated 6% | Treated 18% |
|---|---|---|---|
| 5 | −5.83 | −3.02 | −4.50 |
| 10 | −5.59 | −4.64 | −4.14 |
| 15 | −7.20 | −5.85 | −5.04 |
| 20 | −9.18 | −6.06 | −4.91 |

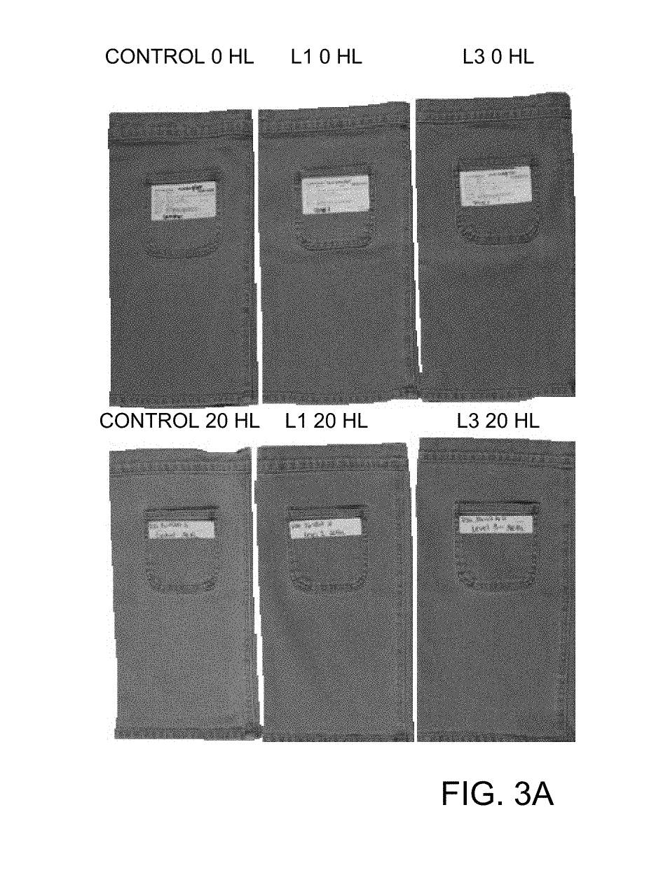

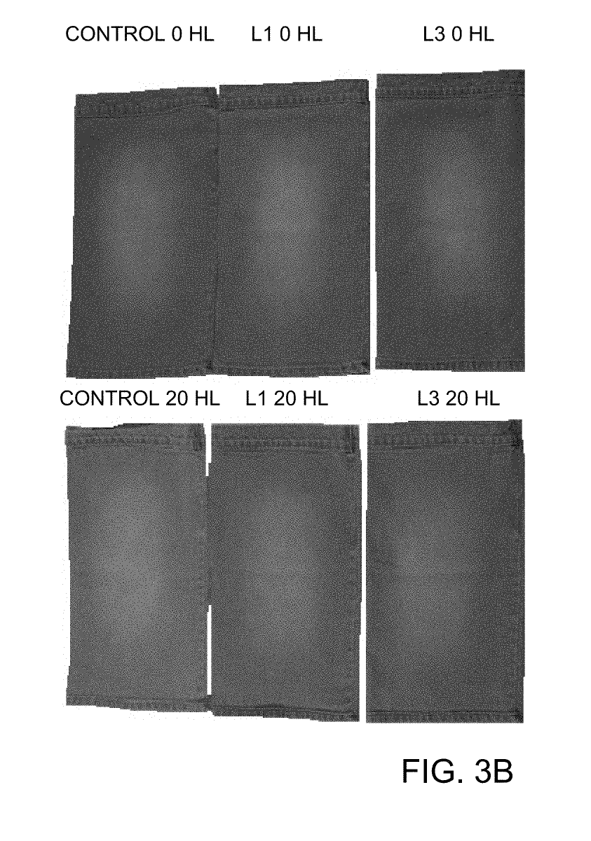

The qualitative visual information provided in FIGS. 3A and 3B shows that treated panels retained color better than untreated panels, as there were smaller changes with HL cycles in the L- and B-values of the treated panels.

What is claimed:

1. A method for treating a garment, comprising the following steps:
a) fabricating a garment, the garment optionally comprising denim;
b) optionally performing a dry finishing on the garment;
c) optionally performing a wet finishing on the garment;
d) optionally tinting the garment;
e) washing the garment with an amount of a contrast material that that comprises perpendicular light-polarizing axes, the washing giving rise to a treated garment. f) optionally: treating the garment with resin, tinting the garment, curing the garment, or fixing the garment;
g) drying the garment; and
h) optionally curing the garment.

2. The method of claim 1, wherein the contrast material is present during the washing at from about 1 to about 50 wt % of the garment weight.

3. The method of claim 1, wherein (a) the treated garment has a drape coefficient of from about 1 to about 100%, (b) the treated garment has a drape coefficient that differs from the drape coefficient of the garment before washing by at least about 2%, or both (a) and (b).

4. The method of claim 1, wherein the treated garment has a Delta E CMC of less than about 5 following 5 washes under standard conditions.

5. The method of claim 1, wherein the pre-treatment garment is substantially free of the contrast material.

6. The method of claim 1, wherein the treated garment is characterized as having an inner surface and an outer surface, and wherein a concentration of the contrast material has maxima at the inner surface and outer surface of the garment.

7. A treated garment made according to claim 1.

8. The treated garment of claim 7, wherein (a) the garment exhibits a stretch recovery of from about 85 to about 100% and/or of at least 1% (per ASTM D3701), (b) the garment comprises pervious materials and all pervious materials of the garment comprise an amount of the contrast material, or (a) and (b).

9. A garment manufacturing system, comprising:
a pre-treatment garment fabrication stage;
a garment stage, comprising
(a) a receiving vessel for pre-treatment garments,
(b) a dispenser configured to dispense a treatment into the receiving vessel so as to effect application of the treatment to pre-treatment garments disposed within the vessel so as to give rise to treated garments, and
(c) a supply of a contrast material that comprises perpendicular light-polarizing axes, the supply of contrast material optionally being in fluid communication with the dispenser.

10. The garment manufacturing system of claim 9, wherein the system is configured to effect application of the treatment at from about 0.1 to about 50 wt % of pre-treatment garments present in the receiving vessel.

11. The garment manufacturing system of claim 9, wherein the system is configured to give rise to treated garments having a drape coefficient of from about 1 to about 100%.

20. The method of claim 17, wherein the treating gives rise to a treated garment having a Delta E CMC of less than about 5 following 5 washes under standard conditions.

12. The garment manufacturing system of claim 9, wherein the system is configured to give rise to treated garments having a Delta E CMC of less than about 5 following 5 washes under standard conditions.

13. The garment manufacturing system of claim 9, wherein the pre-treatment garments are substantially free of the contrast material.

14. The garment manufacturing system of claim 9, wherein the system is configured such that application of the contrast material effects a Delta E CMC in the pre-treatment garments of less than about 10%.

15. The garment manufacturing system of claim 9, wherein the system is configured to give rise to a non-uniform concentration of the contrast material as a function of depth through a thickness of a treated garment.

16. The garment manufacturing system of claim 9, further comprising at least one of (a) a dry finishing stage configured to effect a dry finishing on a garment or pre-treatment garment and (b) a wet finishing stage configured to effect a wet finishing on a garment or pre-treatment garment.

17. A method for preserving one or more aesthetics of a garment, comprising:
treating a garment with a contrast material; and
optionally performing one or more of: a wet finishing on the garment, a dry finishing on the garment, treating the garment with resin, tinting the garment, curing the garment, or fixing the garment.

18. The method of claim 17, wherein an aesthetic comprises a color depth, a contrast, a drape, a softness, a color fastness to washing, or a color fastness to rubbing.

19. The method of claim 17, wherein the treating effects an increase in a color depth of from about 20% to about 100%.
